(19) United States
(12) Patent Application Publication
(10) Pub. No.: US 2015/0113064 A1
(43) Pub. Date: Apr. 23, 2015

(54) Network Information Push Method and System Thereof, and Computer Storage Medium

(71) Applicant: Tencent Technology (Shenzhen) Company Limited, Guangdong (CN)

(72) Inventors: Ziming Chen, Guangdong (CN); Yiguo Yang, Guangdong (CN); Yingyi Jiang, Guangdong (CN)

(73) Assignee: Tencent Technology (Shenzhen) Company Limited, Guangdong (CN)

(21) Appl. No.: 14/580,395

(22) Filed: Dec. 23, 2014

Related U.S. Application Data
(63) Continuation of application No. PCT/CN2013/077896, filed on Jun. 25, 2013.

(30) Foreign Application Priority Data
Jun. 28, 2012 (CN) 201210220443.2

(51) Int. Cl. H04L 29/08

(52) U.S. Cl. CPC H04L 67/26; H04L 67/306; H04L 67/22
USPC 709/204

(57) ABSTRACT

Network information push is described. The described techniques include: obtaining friend information of a user according to user identity of the user, and determining whether any friends of the user have interactions with a corresponding network service; and if yes, pushing to the user information about the network service and information about the interactions occurred between the user's friends and the network service. With the method and system of the present disclosure, information about the network services and information about the interactions occurred between the user's friends and the network service are pushed initiatively to the user without the need to collect information by the user, which is more convenient and efficient. Further, since the interaction information is obtained according to the friend information of the user, it may have higher correlation with the user, and thus improve the accuracy of information push.

### CROSS REFERENCE TO RELATED APPLICATIONS

This application is a continuation application of the PCT International Application No. PCT/CN2013/077896, filed Jun. 25, 2013, entitled “NETWORK INFORMATION PUSH METHOD AND SYSTEM THEREOF, AND COMPUTER STORAGE MEDIUM”, which claims priority to Chinese patent application no. CN 201210220443.2, filed Jun. 28, 2012. The above-referenced applications are hereby incorporated in their entireties by reference.

### FIELD

The present disclosure relates generally to the field of network information technology, and more particularly, to a network information push method and the system thereof

### BACKGROUND

With the development of network technology, more and more network services are developed and applied. Network users, however, are generally cautious in choosing from a variety of network services. They would like to know about a new network service before deciding whether to use it or not.

Usually, the users have limited options when they want to know about a new network service: accessing the webpage of the network service to read the instruction, online searching for network service related commentary, or asking the other users who once used the network service. All of these options require the users to collect relevant information on their own, which is not convenient, and even time-consuming and inefficient.

### SUMMARY

To address the aforementioned deficiencies and inadequacies, the present disclosure aims to provide a network information push method that enables pushing to users information about corresponding network services without the need to collect information by the users, which is more convenient and efficient.

According to one aspect of the disclosure, a network information push method includes:

obtaining friend information of a user according to user identity of the user, and determining whether any friends of the user have interactions with a corresponding network service; and

if yes, pushing to the user information about the network service and information about the interactions occurred between the user's friends and the network service.

According to another aspect of the disclosure, a network information push system running on a computer system including a processor and a system memory is provided, the system memory including:

an information search module, configured to obtain friend information of a user according to user identity of the user, and determine whether any friends of the user have interactions with a corresponding network service; and

an information push module, configured to push, when the determination result is YES, to the user information about the network service and information about the interactions occurred between the user's friends and the network service.

According to yet another aspect of the disclosure, a non-transitory computer-readable storage medium including an executable program to execute a network information push method is provided, the method including:

obtaining friend information of a user according to user identity of the user, and determining whether any friends of the user have interactions with a corresponding network service; and

if yes, pushing to the user information about the network service and information about the interactions occurred between the user's friends and the network service.

With the network information push method and system according to embodiments of the present disclosure, information about the network services and information about the interactions occurred between the user's friends and the network service are pushed initiatively to the user. The users will not need to collect information about the network services, thus it is more convenient and efficient.

Further, since the interaction information is obtained according to the friend information of the user, it may have higher correlation with the user, and thus improve the accuracy of information push.

### BRIEF DESCRIPTION OF THE DRAWINGS

FIG. 1 is a schematic diagram showing a flow of a network information push method according to an embodiment of the present disclosure.

FIGS. 2-4 are schematic diagrams showing the information pushing using network information push methods according embodiments of the present disclosure.

FIG. 5 is schematic diagram showing a flow of application of a network information push method according to an embodiment of the present disclosure.

FIG. 6 is a structural schematic diagram showing a network information push system according to an embodiment of the present disclosure.

FIG. 7 is a schematic block diagram showing an operating environment in which embodiments of the present disclosure may be implemented.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

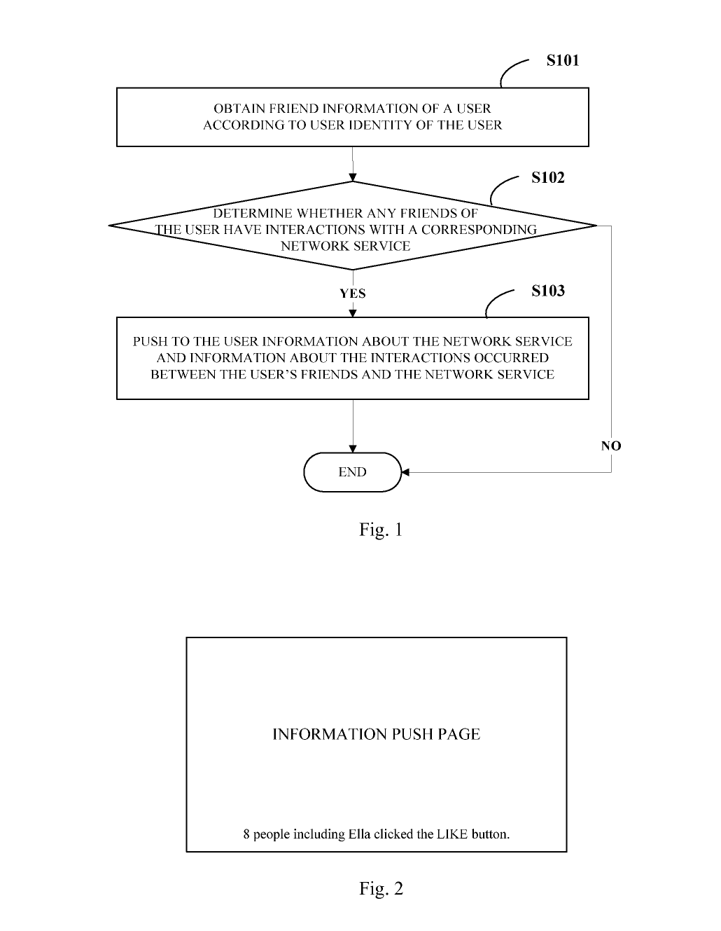

FIG. 1 is a schematic diagram showing a flow of a network information push method according to an embodiment of the present disclosure.

The network information push method includes the steps of:

Step S101, obtaining friend information of a user according to user identity of the user.

A user identity preferably records, in a variety of social networking systems, information about the friend information of a user, such as a login account and password of instant messaging software or a social networking site. In this step, friend information of a user, such as friend list containing user identities of the friends, may be obtained from the corresponding social networking system according to the user identity.

Further, various triggering conditions can be set in the network information push method of the embodiment. When the trigger conditions are met, the network information push method of the embodiment will be performed. Trigger conditions, such as receiving instructions initiatively triggered and executed by the user, accessing to related sites of the network services by the user, or starting applications associated with the network service by the user, all can be used to trigger the execution of the network information push method.

The network services include a variety of network services provided on the web for users to access or apply, including online games, plug-ins of applications, and online shopping services, etc.

Step S102, determining whether any friends of the user have interactions with a corresponding network service;

if yes, then perform Step S103; otherwise, end the flow.

In this embodiment, the step of determining whether any friends of the user have interactions with a corresponding network service according to friend information of a user may include:

searching in a database for information about the interactions occurred between the user's friends and the network service; if the interaction information is found, it indicates that the user's friends have had interactions with a corresponding network service, and information about the interactions occurred between the user's friends and the network service are obtained from the database;

otherwise, determining that no interaction has occurred between the user's friends and the network service.

The database may include statistical database of the network service, or database of various social networking systems containing friend information of the user. After obtaining the corresponding friend information, the information about interactions occurred between the user's friends and the network services are searched in the database according to the user identity of the respective friend in the friend information.

The interaction information may includes information about a variety of interactions occurred between the user's friends and the network services, including participating in the online games, installing corresponding application plug-ins, or online buying the corresponding products, etc.

Step S103, pushing to the user information about the network service and information about the interactions occurred between the user's friends and the network service.

When it is determined that one or more friends of the user have interactions with the corresponding network service, information about the network service and interaction information of the user's friends are pushed to the user.

The information about the network service includes the name, profile, network link and introduction page of the network service.

The interaction information includes one or more selected from the following group:

a user name or nickname;

specific content of the interaction with network service;

time of occurrence of the interaction with the network service;

evaluation of the network service;

number of people that have interactions with the network service.

The ways of information push may include:

sending to the user a pop-up window to display the interaction information; displaying in a relevant page of the network service triggered by the user the information about the network service and the interaction information; alternatively, displaying in an interface of an application associated with the network service the information about the network service and the interaction information. The information about the network service, as well as the interaction information may be displayed preferably in the form of text or graph. Preferably, the obtained interaction information may be pushed to the user after statistical analysis, conversion or screening.

For example, the network service may be a game named Simulated Farm. The interaction information pushed to the user includes: this week, there are 18 friends including Xiaohong and Xiaolv who are playing Simulated Farm, and their evaluation to the game is ‘LIKE’.

Preferably, in Step S103, the interaction information pushed to the user is the information about interactions occurred between the network service and all users who ever have interactions with the network service. That is, the user can not only obtain information about interaction occurred between the friends and the network service, but also obtain information about interactions occurred between users who are not friends of the user and the network service. This may help to obtain more comprehensive and objective information. Statistical data of information about interactions occurred between the network service and all users who ever have interactions with the network service may be obtained from the server of the network service.

Further, when pushing to the user the information about interactions occurred between the user's friends and the network service, the interaction information of a number of several friends who recently have interactions with the network service may be pushed to the user according to time order of interactions occurred between each friend and the network service. In this way, it is possible to display to the user the latest interaction information of friends and the latest information.

In practical use, the types of interaction information to be pushed may be selected according to specific needs. For example, the nickname of the user's friend, the total number of users who have interactions with the network service, and the specific content of their interactions and the like may be pushed at the same time, as shown in FIG. 2.

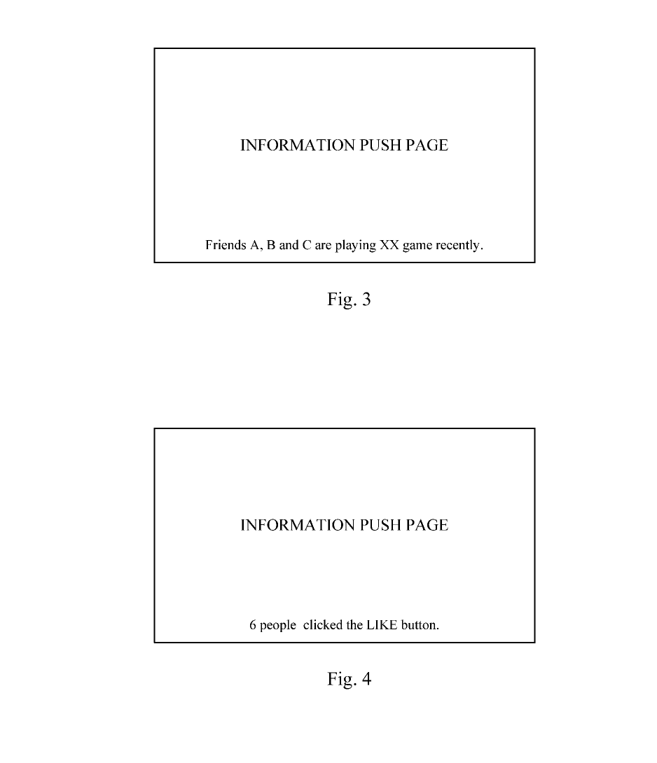

Alternatively, the nickname of the user's friend, the total number of friends who have interactions with the network service, and the specific content of the interactions occurred between the friends and the network and the like may be pushed at the same time, as illustrated in FIG. 3.

After Step S102, if no friend has ever had interaction with the network service, then no information about interaction between the user's friend and the network service will be pushed to the user. But it is still possible to push to the user the network service information and information about interactions occurred between the network service and all users who have had interactions with the network service. For example, the total number of users who have interactions with the network service and the specific content of their interactions may be pushed, as illustrated in FIG. 4.

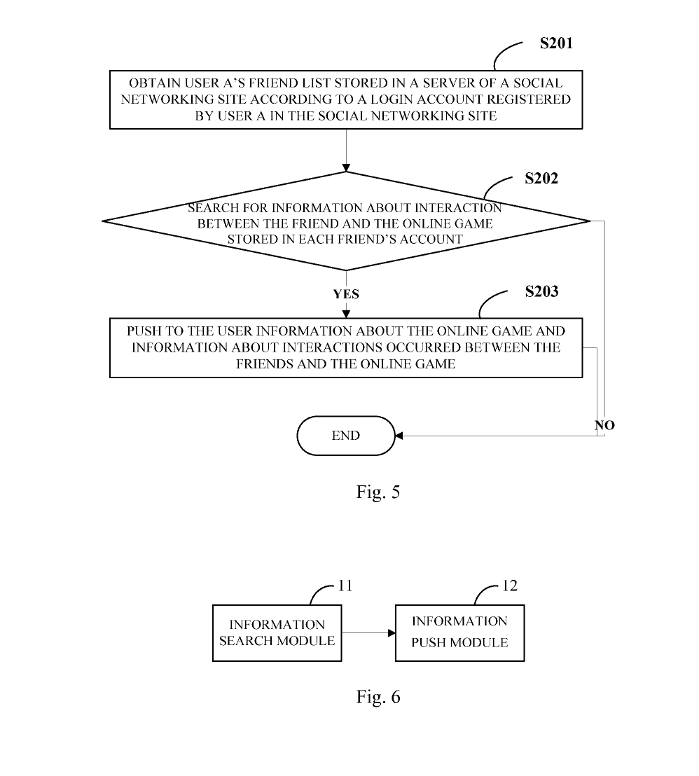

With reference to FIG. 5, the implementation of the network information push method of the embodiment will be illustrated in detail taking social networking sites for example.

Assume that the network service is a new online game launched by a social networking site; it needs to push to User A information about the online game. Thus, the following steps are performed using the network information push method of the present embodiment.

Step S201, obtaining User A's friend list stored in a server of a social networking site according to a login account registered by User A in the social networking site.

Assume that the interaction information about each user with the online game is stored in the server of the social networking site, including whether to participate in the online game, participation time, and evaluation of the network game. It should be noted that the interaction information may also be stored in the server of the network game or other server specifically provided. In this embodiment, the interaction information may be obtained from the corresponding server; thus, there is no particular limitation to the source of the interaction information.

Step S202, searching, according to the respective friend's login account in the friend list, in the server of the social networking site for information about interaction between the friend and the online game stored in each friend's account. If it is found, then extract the corresponding interaction information from the server of the social networking site and perform Step S203; otherwise, end the process.

Step S203, pushing to the user information about the online game and information about interactions occurred between the friends and the online game. The interaction information is statistically summarized and displayed in a pop-up window to show the information about the network service. The interaction information includes the number of friends participating in the online game, friend's nickname, participation time and the evaluation of the online game.

With the network information push method of the embodiment, information about interactions occurred between a user's friends and a corresponding network service can be pushed to the user initiatively without the need to collect information by the users, which is more convenient and efficient compared with the prior art. Moreover, since the interaction information is obtained according to the user's friend information, it may have a higher correlation with the user, which may help to improve the accuracy of information push.

The method of the disclosure as described above can be in the form of computer software installed on particular equipment, and can be performed by controlling relevant processing devices when the software is running.

FIG. 6 is a structural schematic diagram showing a network information push system according to an embodiment of the present disclosure.

The network information push system of the present disclosure includes an information search module 11 and an information push module 12. The information search module 11 is configured to obtain friend information of a user according to user identifier of the user and to determine whether any friends of the user have interactions with a corresponding network service. The information push module 12 is configured to push to the user, when the determination result is YES, information about the network service and information about the interactions occurred between the user's friends and the network service.

A user identity preferably records, in a variety of social networking systems, information about the friend information of a user, such as a login account and password of instant messaging software or a social networking site. The information search module 11 may be configured to obtain friend information of a user, such as friend list containing user identities of the friends, from the corresponding social networking system according to the user identity.

Further, various triggering conditions can be set in the network information push system of the embodiment. When the trigger conditions are met, the network information push system of the embodiment will be triggered to start information push. For example, when receiving instructions initiatively triggered and executed by the user, when accessing to related sites of the network services by the user, or when starting applications associated with the network service by the user, the network information push system will be triggered to automatically pushing relevant network information.

The network services include a variety of network services that are provided on the web for users to access or apply and require information push, including online games, plug-ins of applications, or online shopping services.

Determining, by the information search module 11 and according to friend information obtained above, whether any friends of the user have interactions with a corresponding network service may include:

searching in a database for information about the interactions occurred between the user's friends and the network service; if the interaction information is found, it indicates that friends of the user have had interactions with a corresponding network service, and information about the interactions occurred between the user's friends and the network service are obtained from the database;

otherwise, determining that no interactions occurred between the user's friends and the network service.

The database may include statistical database of the network service, or database of various social networking systems containing friend information of the user. After the information search module 11 obtains the corresponding friends information, the information about interactions occurred between the user's friends and the network services are searched in the database according to the user identity of the respective friend in the friend information.

The interaction information may includes information about a variety of interactions occurred between the user's friends and the network services, including participating in the online games, installing corresponding application plug-ins, or online buying the corresponding products, etc.

The information push module 12 may be configured to push to the user, when the information search module 11 determines that one or more friends of the user have interactions with the corresponding network service, information about the network service and interaction information of the user's friends.

The information about the network service includes the name, profile, network link and introduction page of the network service.

The interaction information includes one or more selected from the following group:

a user name or nickname;

specific content of the interaction with network service;

time of occurrence of the interaction with the network service;

evaluation of the network service;

number of people that have interactions with the network service.

The ways of pushing, by the information push module 12, to the user information about the network service may include:

sending to the user a pop-up window to display the interaction information; displaying in a relevant page of the network service triggered by the user the information about the network service and the interaction information; alternatively, displaying in an interface of an application associated with the network service the information about the network service and the interaction information. The information about the network service, as well as the interaction information may be displayed preferably in the form of text or graph. Preferably, the obtained interaction information may be pushed to the user after statistical analysis, conversion or screening.

For example, the network service may be a game named Simulated Farm. The interaction information pushed to the user includes: this week, there are 18 friends including Xiaohong and Xiaolv who are playing Simulated Farm, and their evaluation to the game is ‘LIKE’.

Preferably, the information push module 12 may further be configured to push to the user information about interactions occurred between the network service and all users who ever have interactions with the network service. That is, the user can not only obtain information about interaction occurred between the friends and the network service, but also obtain information about interactions occurred between the other non-friend-users and the network service. This may help to obtain more comprehensive and objective information. Statistical data of information about interactions occurred between the network service and all users who ever have interactions with the network service may be obtained from the server of the network service.

Further, when the information push module 12 is pushing to the user the information about interactions occurred between the user's friends and the network service, the interaction information of the several friends who recently have interactions with the network service may be pushed to the user according to time order of interactions occurred between each friend and the network service. In this way, it is possible to display to the user the latest interaction information of friends and the latest information.

In practical use, the types of interaction information to be pushed may be selected according to specific needs. For example, the nickname of the user's friend, the total number of users who have interactions with the network service, and the specific content of their interactions and the like may be pushed at the same time.

Alternatively, the nickname of the user's friend, the total number of friends who have interactions with the network service, and the specific content of the interactions occurred between the friends and the network and the like may be pushed at the same time.

When the information search module 11 determines that no friend has ever had interaction with the network service, no friend has ever had interaction with the network service, then no information about interaction between the user's friend and the network service will be pushed to the user. But it is still possible to push to the user the network service information and information about interactions occurred between the network service and all users who have had interactions with the network service. For example, the total number of users who have interactions with the network service and the specific content of their interactions may be pushed.

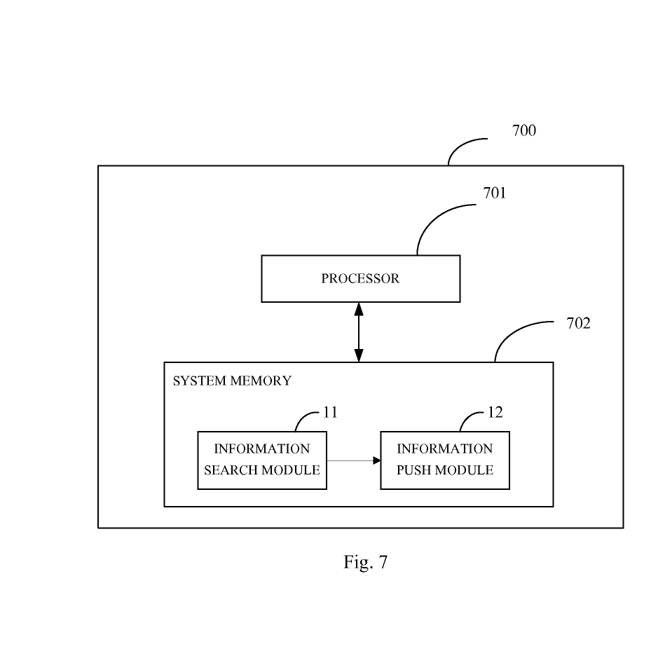

FIG. 7 is a schematic block diagram of an operating environment in which embodiments of the present disclosure may be implemented. The computer system 700 is configured to push to one or more software entities the network information. As shown in FIG. 7, the computer system 700 includes a processor 701 and a system memory 702.

The computer system 700 is intended to broadly represent any processor-based systems, in which software can be executed for the benefit of users. For example, the computer system 700 may include desktop computer systems, laptop computers or tablet computers. Further, the computer system 700 may include video game systems, personal digital assistants (PDA), smart phones or portable media players.

The processor 701 includes one or more processors or processor cores configured to execute software modules and access data stored in the system memory 702. The software module stored in the system memory 702 includes at least an information search module 11 and an information push module 12. The system storage 702 is intended to broadly represent any types of storage that can be used to store software module and data to be executed and accessed by the processor. In one embodiment, the system memory 702 includes volatile memory, such as random access memory (RAM).

It should be noted that for a person skilled in the art, partial or full process to realize the methods in the above embodiments can be accomplished by related hardware instructed by a computer program. The program can be stored in a computer readable storage medium and the program can include the process of the embodiments of the above methods. Wherein, the storage medium can be a disk, a light disk, a Read-Only Memory or a Random Access Memory, etc.

The embodiments are chosen and described in order to explain the principles of the disclosure and their practical application so as to allow others skilled in the art to utilize the disclosure and various embodiments and with various modifications as are suited to the particular use contemplated.

Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. A network information push method, comprising:
obtaining friend information of a user according to user identity of the user, and determining whether any friends of the user have interactions with a corresponding network service; and
if yes, pushing to the user information about the network service and information about the interactions occurred between the user's friends and the network service.

2. The method of claim 1, wherein the information about the interactions further comprises information about the interactions occurred between users who are not friends of the user and the network service.

3. The method of claim 1, wherein the step of determining comprises: searching, according to the friend information of the user, in a database for information about the interactions occurred between the user's friends and the network service; if the interaction information is found, it indicates that the user's friends have had interactions with a corresponding network service, and information about the interactions occurred between the user's friends and the network service are obtained from the database; otherwise, determining that no interaction has occurred between the user's friends and the network service.

4. The method of claim 1, wherein the step of pushing to the user information about the interactions occurred between the user's friends and the network service comprises: pushing to the user the interaction information of a number of friends who recently have interactions with the network service according to time order of interactions occurred between each friend and the network service.

5. The method of claim 1, wherein the interaction information comprises one or more selected from the following group: a user name or nickname; specific content of the interaction with network service; time of occurrence of the interaction with the network service; evaluation of the network service; number of people that have interactions with the network service.

6. A network information push system running on a computer system including a processor and a system memory, the system memory comprising:
an information search module, configured to obtain friend information of a user according to user identity of the user, and determine whether any friends of the user have interactions with a corresponding network service; and
an information push module, configured to push, when the determination result is YES, to the user information about the network service and information about the interactions occurred between the user's friends and the network service.

7. The system of claim 6, wherein the information push module is configured to push the information about the interactions containing interactions occurred between users who are not friends of the user and the network service.

8. The system of claim 6, wherein the information search module is configured to search, according to the friend information of the user, in a database for information about the interactions occurred between the user's friends and the network service; if the interaction information is found, it indicates that the user's friends have had interactions with a corresponding network service, and information about the interactions occurred between the user's friends and the network service are obtained from the database; otherwise, determining that no interaction has occurred between the user's friends and the network service.

9. The system of claim 6, wherein the information push module is further configured to push to the user the interaction information of a number of friends who recently have interactions with the network service according to time order of interactions occurred between each friend and the network service.

10. The system of claim 6, wherein the interaction information comprises one or more selected from the following group: a user name or nickname; specific content of the interaction with network service; time of occurrence of the interaction with the network service; evaluation of the network service; number of people that have interactions with the network service.

11. A non-transitory computer-readable storage medium comprising an executable program, wherein the executable program, when executed, causes a computer to perform network information push, the network information push comprising: obtaining friend information of a user according to user identity of the user, and determining whether any friends of the user have interactions with a corresponding network service; and if yes, pushing to the user information about the network service and information about the interactions occurred between the user's friends and the network service.

12. The non-transitory computer-readable storage medium of claim 11, wherein the information about the interactions further comprises information about the interactions occurred between users who are not friends of the user and the network service.

13. The non-transitory computer-readable storage medium of claim 11, wherein the step of determining comprises: searching, according to the friend information of the user, in a database for information about the interactions occurred between the user's friends and the network service; if the interaction information is found, it indicates that the user's friends have had interactions with a corresponding network service, and information about the interactions occurred between the user's friends and the network service are obtained from the database; otherwise, determining that no interaction has occurred between the user's friends and the network service.

14. The non-transitory computer-readable storage medium of claim 11, wherein the step of pushing to the user information about the interactions occurred between the user's friends and the network service comprises: pushing to the user the interaction information of a number of friends who recently have interactions with the network service according to time order of interactions occurred between each friend and the network service.

15. The non-transitory computer-readable storage medium of claim 11, wherein the interaction information comprises one or more selected from the following group: a user name or nickname;
specific content of the interaction with network service; time of occurrence of the interaction with the network service; evaluation of the network service; number of people that have interactions with the network service.
